(19) United States
(12) Patent Application Publication
(10) Pub. No.: US 2009/0156724 A1
(43) Pub. Date: Jun. 18, 2009

(54) USE OF GLYCEROL AS ADDITIVE FOR FORMALDEHYDE-FREE AQUEOUS SIZES

(75) Inventors: Philippe Espiard, Gouvieux (FR); Eva Wagno, Altir (DE)

Correspondence Address: OBLON, SPIVAK, MCCLELLAND MAIER & NEUSTADT, P.C., 1940 DUKE STREET, ALEXANDRIA, VA, 22314, US

(73) Assignee: SAINT-GOBAIN ISOVER, Courbevoie (FR)

(21) Appl. No.: 11/569,254

(22) PCT Filed: May 17, 2005
(86) PCT No.: PCT/FR05/01239

§ 371 Date: Dec. 26, 2006

(30) Foreign Application Priority Data
May 17, 2004 (DE) 10 2004 024 380.8

(51) Int. Cl. C08K 5/05

(52) U.S. Cl. 524/388

(57) ABSTRACT

The present invention relates to the use of glycerol as additive for formaldehyde-free aqueous sizes based on acrylic or acrylate polymers, which are intended for the manufacture of products based on mineral wool, in order to improve the aging resistance of the products based on mineral wool that are obtained after the size has been crosslinked. The products based on mineral wool bound with such a size, which is environmentally friendly, have the same quality as products conventionally bound with a phenolic resin. The thickness recovery and flexure of the products obtained are improved.

The present invention relates to the use of glycerol as additive for formaldehyde-free aqueous sizes based on acrylic or acrylate polymers crosslinked by a polyol for the manufacture of mineral wool.

To manufacture mineral wool, in particular rock wool and glass wool, it has been known for a long time to apply a size based on a phenol-formaldehyde resin to the fibers, preferably in a hood after the fiberizing operation, for example after the attenuation by blowing as described in DE 35 09 426 A1.

In this method, a phenol-formaldehyde resin known from most sizes of the prior art is sprayed onto the fibers, preferably as an aqueous solution or dispersion, and said resin starts to polymerize on the surface of the fibers while they are still hot. Next, the individual fibers are connected together under the effect of the polymerization, especially at the points of intersection, the fibers located at the top of the points being virtually encapsulated in droplets of solidified resin; consequently, the mobility of the individual fibers relative to one another is limited or prevented when they are crosslinked by hot air in the oven.

To avoid environmental pollution problems, more and more trials are still being undertaken in order to replace conventional sizes based on phenolic resins, which contain among other things formaldehyde, with sizes that do not contain formaldehyde.

For example, EP 0 583 086 B2 describes a formaldehyde-free crosslinkable aqueous size composition for glass fibers based on polyacid polymers having at least two carboxylic acid groups or anhydride groups, comprising a polyol containing at least two hydroxyl groups and a phosphorus-containing catalyst, in which composition the ratio of COOH groups to OH groups varies from 1/0.01 to 1/3.

In EP 0 583 086 B2, the polyacid is for example an acrylic polyacid.

As polyol, it is preferred to use a p-hydroxyalkylamide, for example [N,N-di(β-hydroxyethyl)]adipamide; however, ethylene glycol, glycerol, pentaerythritol, trimethylolpropane, sorbitol, sucrose, glucose, resorcinol, catechol, pyrogallol, glycolated ureas, 1,4-cyclohexanediol, diethanolamine and triethanolamine may for example also be used.

Similar size compositions for mineral fibers are also known from U.S. Pat. No. 6,331,350 B1, EP 0 990 727 A1, EP 0 990 728 A1 and EP 0 990 729 A1. This prior art uses an acrylic polyacid as polyacid. Here, alkanolamines, just like glycols, are used as polyol.

EP 0 882 774 B1 also describes size compositions for mineral fibers that contain acrylic polyacids and glycols as polyols.

Such compositions for mineral fibers are commercially available under the name ACRODUR® from BASF Aktiengesellschaft, Ludwigshafen.

In all the documents cited from the prior art, the polyols are employed as crosslinking agents since their OH functional groups form ester bonds with the COOH groups of the polyacid.

Before the crosslinking, the polyacrylamide resins crosslinked by a polyol, in particular ACRODUR®, have thermoplastic properties. After the thermal crosslinking, these properties are converted into thermosetting properties, being accompanied by a considerable increase in the elastic modulus. In other words, there is a risk of embrittlement and aging of the resins.

When an aqueous solution of a conventional composition based on a polyacrylamide resin crosslinked by a polyol is sprayed onto the mineral fibers, for example in a hood after fiberizing, considerable difficulties arise after the crosslinking, for example in an oven, in order for the manufactured products based on mineral wool to maintain a level of aging resistance or thickness recovery and a flexure that remain acceptable for the user.

These difficulties stem among others from the fact that the resins based on a chemistry different from that of phenolic resins exhibit modified mechanisms and reaction kinetics that do not correspond to the usual conditions for manufacturing mineral wool.

The object of the present invention is, on the basis of the prior art according to EP 0 882 074 B1, to provide a formaldehyde-free aqueous size for the manufacture of products based on mineral wool that remedies the abovementioned drawbacks.

This object is achieved by using glycerol to improve the aging resistance of products based on mineral wool obtained after crosslinking the size.

The use of glycerol in size compositions based on acrylic polymers or ready-to-use size compositions based on acrylates crosslinked by a polyol has the effect of retarding evaporation of water. Consequently, the raw fiber mats (primitive felts) have a higher moisture content. A higher moisture content in the raw fiber mats prevents premature drying of the size which, in the even, must penetrate in a wet and tacky state so as to stabilize the desired bonds between the fibers.

Furthermore, the rheological and wetting properties of the size are modified and have a beneficial effect on the distribution of the size on the mineral fibers.

Surprisingly, it has been found that the addition of glycerol to a size based on an acrylic or acrylate resin significantly improves the aging resistance of products based on mineral wool. The results of trials carried out over the course of a pilot study have demonstrated that the aging characteristics after the addition of glycerol are improved by 5% in the case of thickness recovery and up to 40% in the case of flexure.

The present invention relates in particular to the use of glycerol as additive for formaldehyde-free aqueous sizes based on acrylic or acrylate polymers crosslinked by a polyol for the manufacture of mineral wool with a view to improving the aging resistance of mineral wool obtained after the size has been crosslinked.

For this purpose, it is preferable for the glycerol to be added to the acrylic or acrylate size, that is to say to a ready-to-use solution, in a concentration of about 2 to 20% by weight, in particular 5 to 10% by weight.

The addition of glycerol thus improves the thickness recovery by at least 5%, in particular about 10%, and the flexure by about 10 to 40%, more particularly about 30%.

Thickness recovery is a measure of the thickness excess that the mineral wool product has to have during manufacture in order to achieve its final thickness at the place of use after the compressive forces have been removed, taking into consideration all of the compression processes resulting from packaging, storage and transportation.

For example, if a laminated roll of mineral wool for insulation between the rafters of a roof has to have a required thickness of about 140 mm, it must be manufactured with a significantly greater thickness, for example about 155 mm, so as to have the intended 140 mm thickness after being unrolled at the point where it is to be laid. The product recovers to practically the thickness that it had originally after being manufactured. The explanation of this effect is based on the fact that elastic properties are conferred on the fibers during manufacture, these properties being due, on the one hand, to purely mechanical entanglement of the fibers and, on the other hand, to the additives, such as the sizes and their additives, which means that the crosslinked wool may be compressed to a relatively large amount for transportation requirements, that is to say it is compressed and a certain elasticity is thus lost.

The present invention has in this case a particular advantage—the necessary thickness excess within the context of thickness recovery is of course accompanied by a greater mass of fibers in the product. From the economic standpoint, on the basis of yearly production of 60 000 to 90 000 tonnes of mineral fiber, such a thickness excess represents a considerable number of tonnes in order to achieve the “thickness recovery” effect.

Calculations by the inventors have shown that, by modifying the acrylic size with glycerol, up to 4% by weight of fibrous material may be saved for an increase in thickness recovery of only 5% depending on the as-manufactured thickness of the product. For an average production of 75 000 tonnes per year, this represents an annual saving of about 3000 tonnes of material.

The acrylic polymer used in the composition of the size

may be an acrylic acid polymer or a copolymer of acrylic acid with another ethylenically unsaturated monomer, particularly maleic anhydride.

A formaldehyde-free size that has proved to be particularly suitable contains a polymer obtained by radical polymerization of an ethylenically unsaturated dicarboxylic acid, it being possible for the carboxylic acid groups to form an anhydride group, in a content consisting of 5 to 100% by weight of polymer, an alcanolamine containing at least two hydroxyl groups and less than 1.5% by weight of a phosphorus-containing accelerator relative to the total weight of polymer and of alcanolamine. Such sizes are for example available under the brand name ACRODUR® from BASF, Ludwigshafen.

Other advantages and features of the invention will be presented in the examples and the drawings that follow.

The drawings show:

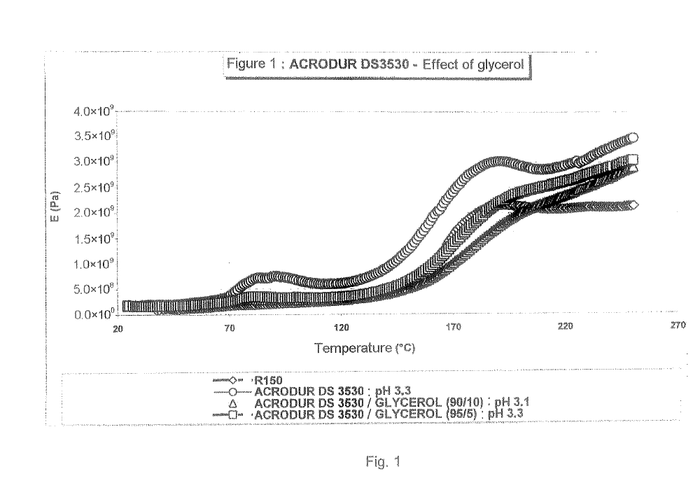

FIG. 1, the variation in elastic modulus as a function of temperature for a reference size based on a phenol-formaldehyde resin, an acrylate size with no addition of glycerol, and the same acrylate size with various proportions of glycerol;

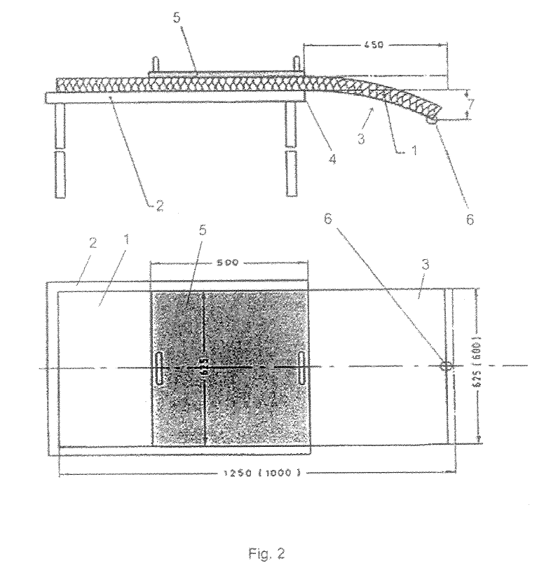

FIG. 2, the test device for measuring flexure.

### EXAMPLE 1

A commercially available acrylate resin was used for the preparation of the sizes, in the present case resin ACRODUR DS 3530 from BASF, Ludwigshafen, to which a size oil and a silane were added (Table 1).

TABLE 1
composition of the sizes

| | 100/0 | 95/5 | 90/10 |
|---|---|---|---|
| | ACRODUR size | ACRODUR size | ACRODUR size |
| ACRODUR ® | 6.5 | 6.5 | 6.5 |
| DS 3530 | | | |
| Sizing oil | 0.5 | 0.5 | 0.5 |
| Silane | 0.03 | 0.03 | 0.03 |
| Glycerol | 0 | 0.3 | 0.6 |
| Water | balance | balance | balance |

The size solutions had a pH of 3.3.

The effects of the glycerol will be explained below.
1. Properties of the Size (Elasticity Properties)

The reactivity of the size and the properties of the

binder were measured by dynamic mechanical analysis [DMA] developed by the Applicant, allowing the viscoelasticity of a polymer to be determined.

A filter paper (Whatmann GF/C) was impregnated with the size and held horizontally between fixed jaws. A movable head for measuring tension as a function of deformation was placed near the upper face of the filter paper. From these measurements, the elastic modulus could be calculated.

The impregnated filter paper was heated to 300° C., starting from 20° C., at a rate of 5° C./min. The elastic modulus E (in Pa) as a function of temperature is given in FIG. 1. The measurement method is described in detail in FR 0 304 750 published on Apr. 16, 2004, which is incorporated here for reference.

The method is very suitable for comparing viscoelastic and thermoreactive properties of sizes with those of

the conventional size based on phenol-formaldehyde resin used in the mineral wool industry. This comparison is important since the manufacturing process employs ovens whose conditions are tailored to the crosslinking of the phenol-formaldehyde resin and do not allow reliable results to be obtained when the property profile differs considerably from these conditions—from a practical standpoint, it is difficult to optimize the method under these conditions.

As may be seen in FIG. 1, the measurement of the elastic modulus of the crosslinked sizes examined shows that the addition of glycerol to the acrylate size [95/5 ACRODUR® DS 3530/glycerol], on the basis of solid matter, tends to approach the viscoelastic properties of the phenol-formaldehyde resin [resin R 150]. The use of 10% glycerol [90/10 ACRODUR® DS 3530/glycerol] has a similar effect, while the acrylate size with no added glycerol [ACRODUR® 3530] has elastic properties that vary considerably from the conventional phenol formaldehyde size.

Analysis of the crosslinking with the aid of the elastic modulus taken from Table 1 shows that the addition of glycerol allows the viscosity and the crosslinkability to be adapted to those of the phenolic resin.
2. Properties of the Products Based on Mineral Wool

The practical test on a production line was limited to two sizes, one with no glycerol and one with an added glycerol content of 5%.

As customary, the size was sprayed in a hood onto the still hot fibers before they were collected.

The properties of the products containing these two types of size were compared with those of products sized with a conventional phenol-formaldehyde resin.
2.1. Moisture Content on Raw Fiber Mats
The moisture content of raw fiber mats (Table 2) before their entry into the oven was increased by the addition of glycerol. This increase in moisture content of the raw fiber mats of about 15% by the addition of 5% of glycerol prevents premature drying of the size, which must penetrate, in the oven, in the wet and tacky state in order to stabilize the points of contact between the fibers, with the aim of fixing the displacement and the entanglement of the fibers in a certain mechanical state.

TABLE 2
moisture content of the raw fiber mats

| | Moisture content of the raw |
|---|---|
| Product | fiber mat |
| ACRODUR ® with no glycerol | 8% |
| ACRODUR ® with 5% glycerol | 15% |

2.2 Mechanical Properties

The addition of glycerol had a positive effect on the mechanical properties, in particular as regards aging. The results of the accelerated aging tests are given in Table 3.

TABLE 3
improvement in aging properties

| | Phenolic | | ACRODUR ® + | |
|---|---|---|---|---|
| | resin | ACRODUR ® | 5% glycerol | Saving |
| Flexure | [mm] | [mm] | [mm] | [%] |
| After | 44 | 45 | 62 | |
| manufacture | | | | |
| After | 85 | 116 | 99 | 15 |
| delivery | | | | |
| After CA/2 | 131 | 166 | 115 | 31 |
| After outdoor | 116 | 193 | 117 | 39 |
| storage | | | | |
| After | 171 | 155 | 160 | |
| manufacture | | | | |
| After | 168 | 147 | 156 | 6 |
| delivery | | | | |
| After CA/2 | 161 | 142 | 150 | 5 |
| After outdoor | 162 | 143 | 150 | 5 |
| storage | | | | |

In Table 3, the “CA/2” and “after outdoor storage” tests were carried out as follows:
   CA/2: the mineral-wool-base products were treated at a temperature of 35° C. in a relative humidity of 95% and a dew point of 34° C. for 48 hours and then the flexure and the thickness recovery were measured according to the DIN 18165-1 standard representative of the aging conditions;
   outdoor storage: the mineral-wool-base products were stored outdoors for 12 weeks before the flexure and thickness recovery were measured.
The flexure measurement was carried out according to an internal method of the Applicant, shown schematically in FIG. 2 in which the upper part is a sectional view of the appropriate test device and the lower part is a top view of the device.

The panels were tested in the delivered state (3 panels in each case) and the felts were tested in the form of specimens measuring 1000 mm×≦600 mm (along the width of the felt, 1 to 2 specimens per roll). Before the test, the specimens 1 were pretreated for 48 hours in a standard atmosphere as defined in the DIN 50014 standard. For the flexure measurement, the specimens 1 were placed on the upper part of the surface 2 of suitable size, in a horizontal position, so that one end 3 extended freely beyond the edge of the table 4 over a length of 450 mm. Next, a load plate 5 was placed on the specimen in such a way that the front edge of the plate 5 was flush with the edge of the surface 4, the plate having dimensions of 625 mm×500 mm and a mass of 6.25 kg in the case of the panels, corresponding to a load of 0.2 kN/m², and the identical dimensions and a mass of 3.125 kg in the case of the felts, corresponding to a load of 0.1 kN/m². Four measurements were carried out on each specimen 1 at the center 6 of the specimen, on the top and bottom faces, and then the specimen was turned through 180° about the vertical axis and again analyzed as indicated. The mean value of the four measurements represents the flexure 7 (in mm).

The term ACRODUR® used in Tables 1 and 3 denotes an acrylate size from BASF, Ludwigshafen, commercially available under the reference ACRODUR® 3530. Obviously, a person skilled in the art knows that all formaldehyde-free aqueous sizes based on an acrylate crosslinked by a polyol may be used within the context of the present invention.

As may be seen from Table 3, the flexure values for ACRODUR® are improved by 15 to 39% relative to the acrylate size with no added glycerol.

It may also be seen that the flexure in the case of an acrylate binder with 5% added glycerol is in all cases equal to that of the conventional size based on a phenol-formaldehyde resin (Table 3, flexure after outdoor storage) or in certain cases better (Table 3, flexure in the case of CA/2).

Furthermore, there is a specific advantage in the fact that the classification of the building material (fire behavior) according to the standard DIN EN 13501, Part 1 is not lower than that of the product with a size based on a conventional phenol-formaldehyde resin.

As regards the second property, namely “thickness recovery” shown in Table 3, which is not dependent on the aging, it may be stated that the thickness recovery values for the acrylate size with 5% glycerol added are slightly inferior to the values for the products based on mineral wool with a phenolic resin binder. Compared with the ACRODUR® acrylate size with no glycerol, the thickness recovery values are, however, improved by 5 to 6%. This represents a considerable saving in terms of fibrous material, as was described in the present invention.

### EXAMPLE 2

Two resins were used for preparing sizes, namely a polyacrylic resin (resin A, sold by Rohm & Haas) and a resin comprising an acrylic acid/maleic anhydride copolymer (resin B, sold by BASF) to which a silane and water were added. Depending on the case, glycerol was added in an amount of 3 and 5 parts per 100 parts of resin A and 5 and 10 parts per 100 parts of resin B, calculated by weight of solid matter.

The size was sprayed onto glass fibers obtained by the known technique of internal centrifugation, by means of a spray ring placed beneath the fiberizing spinner so that the size composition was uniformly distributed over the glass wool formed.

The mineral wool thus sized was collected on a belt conveyor equipped with internal suction boxes that retained the wool in the form of a felt on the surface of the conveyor. The conveyor then ran through an oven maintained at a temperature suitable for polymerizing the size in order to form a binder.

The product obtained was a glass wool felt having a nominal thickness of 80 mm. The following measurements were made on the product:
the thickness recovery, in the following manner: the product was compressed with a degree of compression (defined as the ratio of the nominal thickness to the compressed thickness equal to 6/1 for 1, 12, 30 and 90 days. The thickness recovery corresponds to the ratio of the thickness after the compressive force has been removed to the nominal thickness (expressed as a %);
the tensile strength TS after manufacture (TSₘₐₙ) and after accelerated aging in an autoclave at a temperature of 105° C. and 100% relative humidity for 15 minutes (TS₁₅) and 45 minutes (TS₄₅).

The tensile strength TS was measured according to the ASTM C 686-71T standard on a specimen cut by stamping from the insulating product. The specimen had the shape of a torus 122 mm in length, 46 mm in width and a radius of curvature of the cut along the external edge of 38 mm and a radius of curvature of the cut along the internal edge of 12.5 mm.

The specimen was placed between two cylindrical mandrels of a testing machine, one of which was moved at a constant speed. The failure force F (in gram.force) of the specimen was measured and the tensile strength TS defined by the ratio of the failure force F to the mass of the specimen (gram.force/g) was calculated.

TABLE 4
improvement in the aging properties

| | | | | | Tensile strength TS | | |
|---|---|---|---|---|---|---|---|
| | Thickness recovery (%) | | | | (gram · force/g | | |
| | 1 d | 12 d | 30 d | 90 d | TSₘₐₙ | TS₁₅ | TS₄₅ |
| Resin A | 130 | 118 | 122 | 108 | 262 | 177 | 152 |
| Resin A + | 130 | 117 | 127 | 112 | 266 | 196 | 135 |
| 5% glycerol | | | | | | | |
| Resin A + | 130 | 121 | 127 | 119 | 277 | 188 | 193 |
| 6% glycerol | | | | | | | |
| Resin B | 130 | 118 | 122 | 118 | 253 | 157 | 131 |
| Resin B + | 132 | 116 | 124 | 122 | 265 | 191 | 169 |
| 5% glycerol | | | | | | | |
| Resin B + | 134 | 115 | 123 | 121 | 270 | 178 | 185 |
| 10% glycerol | | | | | | | |

The results of Table 4 show that the addition of glycerol to the size improves the 30-day thickness recovery and the tensile strength after 15 minutes of autoclave treatment.

To summarize, the present invention lends itself perfectly to the manufacture of products based on mineral wool of all kinds, being environmentally friendly by not using formaldehyde, and without loss of quality.

1. The use of glycerol as additive for a formaldehyde-free aqueous size based on acrylic or acrylate polymers, intended for the manufacture of mineral wool, in order to improve the aging resistance of products based on mineral wool obtained after the size has been crosslinked.

2. The use as claimed in claim 1, wherein the glycerol is added to the acrylic or acrylate polymer size in a concentration of about 2 to 20% by weight, in particular about 5 to 10% by weight.

3. The use as claimed in claim 1, wherein the thickness recovery is improved by at least 5%, in particular 10%, by the addition of glycerol.

4. The use as claimed in claim 1, wherein the flexure is improved by about 10 to 40%, in particular about 30%, by the addition of glycerol.

5. The use as claimed in claim 1, wherein a raw fiber mat having a higher moisture content is obtained.

6. The use as claimed in claim 1, wherein the theological properties and the wetting properties are improved.

7. The use as claimed in claim 1, wherein the size comprises an acrylic acid polymer or a copolymer of acrylic acid with another ethylenically unsaturated monomer.

8. The use as claimed in claim 1, wherein ACRODUR® 3530 is used as formaldehyde-free acrylate size.
